(19) United States
(12) Patent Application Publication
(10) Pub. No.: US 2024/0357053 A1
(43) Pub. Date: Oct. 24, 2024

(54) DISPLAY DEVICE AND OPERATING METHOD THEREOF

(71) Applicant: LG ELECTRONICS INC., Seoul (KR)

(72) Inventor: Yong Su YOO, Seoul (KR)

(73) Assignee: LG ELECTRONICS INC., Seoul (KR)

(21) Appl. No.: 18/641,004

(22) Filed: Apr. 19, 2024

(30) Foreign Application Priority Data
Apr. 20, 2023 (KR) 10-2023-0051766

(51) Int. Cl. H04N 7/01; G06T 5/70; G06T 5/73; H04N 19/172; H04N 19/87

(52) U.S. Cl. CPC H04N 7/0117; G06T 5/70; G06T 5/73; H04N 19/172; H04N 19/87

(57) ABSTRACT

Disclosed are a display device and an operating method therefor. According to an aspect of the present disclosure, a display device comprises a video decoder; a display configured to output videos; and a processor configured to control the video decoder, wherein, when a first video frame to be output through the display having a resolution different from that of the previous frame is detected among the video frames decoded by the video decoder, the processor is configured to control a resolution of the first video frame and at least one second video frame which is adjacent to the first video frame to be changed.

### CROSS-REFERENCE TO RELATED APPLICATIONS

Pursuant to 35 U.S.C. § 119 (a), this application claims the benefit of earlier filing date and right of priority to Korean Patent Application No. 10-2023-0051766, filed on Apr. 20, 2023, the contents of which are all hereby incorporated by reference herein in their entireties.

### BACKGROUND OF THE INVENTION

### 1. Field of the Invention

The present disclosure relates to a display device and an operating method thereof.

### 2. Discussion of the Related Art

Recently, the functions of terminals have been diversifying, for example, data and voice communication, taking photos and videos using a camera, recording voice, playing music files through a speaker system, etc., and outputting images or videos on a display.

Some terminals add electronic game play functions or perform multimedia player functions.

As the functions of these terminals become more diverse, they are implemented as multimedia devices (Multimedia players) with complex functions such as taking photos or videos, playing music or video files, playing games, and receiving broadcasts. there is.

### SUMMARY OF THE INVENTION

An object of the present disclosure is to provide a display device and a method thereof that apply Quality of Service (QoS) to changes in the data reception environment, controlling the output of video frames to minimize changes in the user's perceptual resolution.

According to an aspect of the present disclosure, a display device may comprise a video decoder; a display configured to output videos; and a processor configured to control the video decoder, wherein, when a first video frame to be output through the display having a resolution different from that of the previous frame is detected among the video frames decoded by the video decoder, the processor is configured to control a resolution of the first video frame and at least one second video frame which is adjacent to the first video frame to be changed.

According to an aspect of the present disclosure, wherein the processor is configured to control the resolution modification through pre-configured quality factor changes applied to the first video frame and the second video frame, and wherein the quality factor comprises sharpness.

According to an aspect of the present disclosure, wherein, when the resolution of the first video frame is higher than that of the previous video frame, the processor is configured to control the sharpness value of the first video frame to be reduced, and to control the sharpness values for a plurality of second videos frames after the first video frame to sequentially increase.

According to an aspect of the present disclosure, wherein the processor is configured to control the reduced sharpness value to be restored to an original set value in a specific video frame among a plurality of second video frames after the first video frame.

According to an aspect of the present disclosure, wherein the processor is configured to determine whether a scene change is made in the first video frame.

According to an aspect of the present disclosure, wherein, when the resolution of the first video frame is higher than that of the previous video frame but is not a video frame in which a scene change occurs, the processor is configured to control the sharpness value of the first video frame to be reduced, and to control the sharpness value of a second video frame in which a scene change occurs among a plurality of second video frames after the first frame to be restored to an original setting value.

According to an aspect of the present disclosure, wherein the processor is configured to control a sharpness value of a second video frame in which a scene change is not occurred among the plurality of second video frames to be sequentially increased or to be the same sharpness value as the sharpness value of the first video frame.

According to an aspect of the present disclosure, wherein, when the resolution of the first video frame is lower than that of the previous video frame, the processor is configured to control sharpness values to be sequentially reduced from a second video frame to be output first among a plurality of second video frames preceding the first video frame to a second video frame to be output last, and to control the sharpness value of the first video frame to be restored to the original setting value.

According to an aspect of the present disclosure, wherein, when the resolution of the first video frame is lower than that of the previous video frame but is not a video frame for which a scene change is made, the processor is configured to control the sharpness value of a second video frame for which a scene change is to be made among a plurality of second video frames prior to the first video frame to be reduced.

According to an aspect of the present disclosure, wherein the processor is configured to control the sharpness values of one or more second video frames between the second video frame and the first video frame to be subjected to the scene change are sequentially decreased, or to control the sharpness value of the second video frame to be subjected to the scene change is controlling the same sharpness value and to control the sharpness value of the first video frame to be restored to an original set value.

According to an aspect of the present disclosure, wherein the processor is configured to obtain frequency component information of the decoded video frames and detect a video frame whose frequency component is changed among the decoded video frames.

According to an aspect of the present disclosure, wherein, when the resolution of the first video frame is higher than that of the previous video frame or there is no change in frequency component, the processor is configured to control the sharpness value of the first video frame to maintain the originally set sharpness value.

According to an aspect of the present disclosure, wherein the processor is configured to control the sharpness value of a second video frame whose frequency component is changed among a plurality of second video frames after the first video frame to be changed.

According to an aspect of the present disclosure, wherein, when a video frame whose frequency component is changed among the detected decoded video frames is not a scene change video frame, the processor is configured to control a resolution to be changed by adjusting a sharpness value of a scene change video frame which is adjacent to the video frame whose frequency component is changed.

According to an aspect of the present disclosure, a method of operating a display device may include receiving a video signal; decoding the received video signal; detecting a first video frame having a resolution different from that of a previous frame among a plurality of video frames within the decoded video signal; detecting at least one second video frame adjacent to the first video frame; and controlling a resolution of at least one of the detected first video frame and second video frame to be changed.

According to at least one embodiment among various embodiments of the present disclosure, there is an effect that even when Quality of Service (QoS) is applied to changes in the data reception environment, changes in the user's perceptual resolution can be achieved seamlessly or minimized.

According to at least one embodiment among various embodiments of the present disclosure, there is an effect of improving user satisfaction with the use of their display device.

### BRIEF DESCRIPTION OF THE DRAWINGS

FIG. 1 is a block diagram illustrating a configuration of a display device according to an embodiment of the present disclosure.

FIG. 2 is a block diagram of a remote control device according to an embodiment of the present disclosure.

FIG. 3 illustrates an example of an actual configuration of a remote control device according to an embodiment of the present disclosure.

FIG. 4 illustrates an example of using a remote control device according to an embodiment of the present disclosure.

FIG. 5 is a diagram illustrating a horizontal mode and a vertical mode of a stand-type display device according to an embodiment of the present disclosure.

FIG. 6 is a diagram illustrating a video processing method of the display device 100 based on changes in data reception conditions.

FIG. 7 is a diagram illustrating the configuration of a display device 100 that seamlessly handles video processing in response to changes in data reception conditions, according to an embodiment of the present disclosure.

FIGS. 8 to 10 are diagrams illustrating the operation of the display device 100.

FIGS. 11 to 13 are diagrams for explaining the operation of the display device 100.

FIGS. 14 to 16 are diagrams for explaining the operation of the display device 100.

FIGS. 17 to 19 are diagrams illustrating the operation of the display device 100.

FIGS. 20 to 22 are diagrams illustrating the operation of the display device 100.

FIGS. 23 to 25 are diagrams illustrating the operation of the display device 100.

FIG. 26 is a flowchart illustrating an operating method of the display device according to an embodiment of the present disclosure.

### DETAILED DESCRIPTION OF THE PREFERRED EMBODIMENTS

Hereinafter, embodiments of the present disclosure will be described in detail with reference to the drawings. The suffixes “module” and “unit or portion” for components used in the following description are merely provided only for facilitation of preparing this specification, and thus they are not granted a specific meaning or function.

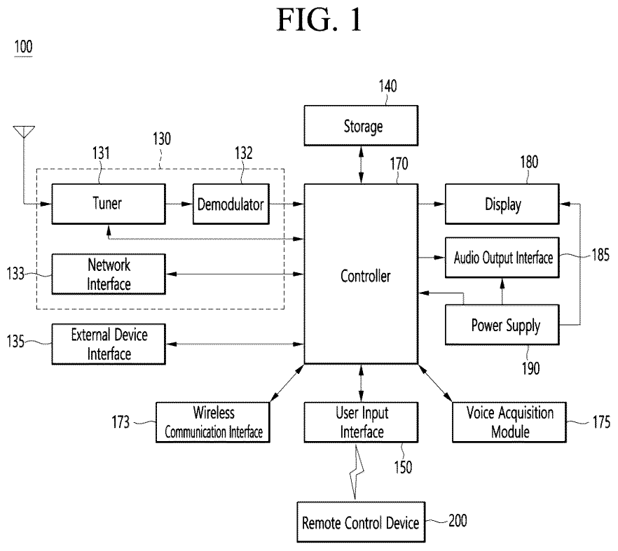

FIG. 1 is a block diagram illustrating a configuration of a display device according to an embodiment of the present disclosure.

Referring to FIG. 1, a display device 100 may include a broadcast receiver 130, an external device interface 135, a memory 140, a user input interface 150, a controller 170, a wireless communication interface 173, a microphone 175, a display 180, a speaker 185, and a power supply circuit 190.

The broadcast receiver 130 may include a tuner 131, a demodulator 132, and a network interface 133.

The tuner 131 may select a specific broadcast channel according to a channel selection command. The tuner 131 may receive a broadcast signal for the selected specific broadcast channel.

The demodulator 132 may separate the received broadcast signal into an image signal, an audio signal, and a data signal related to a broadcast program, and restore the separated image signal, audio signal, and data signal to a format capable of being output.

The network interface 133 may provide an interface for connecting the display device 100 to a wired/wireless network including an Internet network. The network interface 133 may transmit or receive data to or from other users or other electronic devices through a connected network or another network linked to the connected network.

The network interface 133 may access a predetermined web page through the connected network or the other network linked to the connected network. That is, it is possible to access a predetermined web page through a network, and transmit or receive data to or from a corresponding server.

Then, the network interface 133 may receive contents or data provided from a content provider or a network operator. That is, the network interface 133 can receive content such as movies, advertisements, games, VODs (Video on Demands), and broadcast signals, which are provided from a content provider or a network provider, through network and information relating thereto.

In addition, the network interface 133 may receive update information and update files of firmware provided by the network operator, and may transmit data to an Internet or content provider or a network operator.

The network interface 133 may select and receive a desired application from among applications that are open to the public through a network.

The external device interface 135 may receive an application or a list of applications in an external device adjacent thereto, and transmit the same to the controller 170 or the memory 140.

The external device interface 135 may provide a connection path between the display device 100 and an external device. The external device interface 135 may receive one or more of images and audio output from an external device connected to the display device 100 in a wired or wireless manner, and transmit the same to the controller 170. The external device interface 135 may include a plurality of external input terminals. The plurality of external input terminals may include an RGB terminal, one or more High Definition Multimedia Interface (HDMI) terminals, and a component terminal.

The image signal of the external device input through the external device interface 135 may be output through the display 180. The audio signal of the external device input through the external device interface 135 may be output through the speaker 185.

The external device connectable to the external device interface 135 may be any one of a set-top box, a Blu-ray player, a DVD player, a game machine, a sound bar, a smartphone, a PC, a USB memory, and a home theater, but this is an example.

In addition, some content data stored in the display device 100 may be transmitted to another user registered in advance in the display device 100 or a selected user or a selected electronic device among other users or other electronic devices.

The memory 140 may store programs for signal processing and control of the controller 170, and may store images, audio, or data signals, which have been subjected to signal-processed.

In addition, the memory 140 may perform a function for temporarily storing images, audio, or data signals input from an external device interface 135 or the network interface 133, and store information on a predetermined image through a channel storage function.

The memory 140 may store an application or a list of applications input from the external device interface 135 or the network interface 133.

The display device 100 may play back a content file (a moving image file, a still image file, a music file, a document file, an application file, or the like) stored in the memory 140 and provide the same to the user.

The user input interface 150 may transmit a signal input by the user to the controller 170 or a signal from the controller 170 to the user. For example, the user input interface 150 may receive and process a control signal such as power on/off, channel selection, screen settings, and the like from the remote control device 200 in accordance with various communication methods, such as a Bluetooth communication method, a Ultra Wideband (UWB) communication method, a ZigBee communication method, a Radio Frequency (RF) communication method, or an infrared (IR) communication method or may perform processing to transmit the control signal from the controller 170 to the remote control device 200.

In addition, the user input interface 150 may transmit a control signal input from a local key (not shown) such as a power key, a channel key, a volume key, and a setting value to the controller 170.

The image signal image-processed by the controller 170 may be input to the display 180 and displayed as an image corresponding to a corresponding image signal. Also, the image signal image-processed by the controller 170 may be input to an external output device through the external device interface 135.

The audio signal processed by the controller 170 may be output to the speaker 185. Also, the audio signal processed by the controller 170 may be input to the external output device through the external device interface 135.

In addition, the controller 170 may control the overall operation of the display device 100.

In addition, the controller 170 may control the display device 100 by a user command input through the user input interface 150 or an internal program and connect to a network to download an application a list of applications or applications desired by the user to the display device 100.

The controller 170 may allow the channel information or the like selected by the user to be output through the display 180 or the speaker 185 along with the processed image or audio signal.

In addition, the controller 170 may output an image signal or an audio signal through the display 180 or the speaker 185, according to a command for playing back an image of an external device through the user input interface 150, the image signal or the audio signal being input from an external device, for example, a camera or a camcorder, through the external device interface 135.

Meanwhile, the controller 170 may allow the display 180 to display an image, for example, allow a broadcast image which is input through the tuner 131 or an external input image which is input through the external device interface 135, an image which is input through the network interface or an image which is stored in the memory 140 to be displayed on the display 180. In this case, an image being displayed on the display 180 may be a still image or a moving image, and may be a 2D image or a 3D image.

In addition, the controller 170 may allow content stored in the display device 100, received broadcast content, or external input content input from the outside to be played back, and the content may have various forms such as a broadcast image, an external input image, an audio file, still images, accessed web screens, and document files.

The wireless communication interface 173 may communicate with an external device through wired or wireless communication. The wireless communication interface 173 may perform short-range communication with an external device. To this end, the wireless communication interface 173 may support short-range communication using at least one of Bluetooth™, Radio Frequency Identification (RFID), Infrared Data Association (IrDA), UWB, ZigBee, Near Field Communication (NFC), Wi-Fi (Wireless-Fidelity), Wi-Fi Direct, and Wireless USB (Wireless Universal Serial Bus) technologies. The wireless communication interface 173 may support wireless communication between the display device 100 and a wireless communication system, between the display device 100 and another display device 100, or between the display device 100 and a network in which the display device 100 (or an external server) is located through wireless area networks. The wireless area networks may be wireless personal area networks.

Here, the another display device 100 may be a wearable device (e.g., a smartwatch, smart glasses or a head-mounted display (HMD), a mobile terminal such as a smartphone, which is able to exchange data (or interwork) with the display device 100 according to the present disclosure. The wireless communication interface 173 may detect (or recognize) a wearable device capable of communication around the display device 100. Furthermore, when the detected wearable device is an authenticated device to communicate with the display device 100 according to the present disclosure, the controller 170 may transmit at least a portion of data processed by the display device 100 to the wearable device through the wireless communication interface 173. Therefore, a user of the wearable device may use data processed by the display device 100 through the wearable device.

The microphone 175 may acquire audio. The microphone 175 may include at least one microphone (not shown), and may acquire audio around the display device 100 through the microphone (not shown).

The display 180 may convert image signals, data signals, and OSD signals processed by the controller 170, or image signals or data signals received from the external device interface 135 into R, G, and B signals, and generate drive signals.

Meanwhile, since the display device 100 shown in FIG. 1 is only an embodiment of the present disclosure, some of the illustrated components may be integrated, added, or omitted depending on the specification of the display device 100 that is actually implemented.

That is, two or more components may be combined into one component, or one component may be divided into two or more components as necessary. In addition, a function performed in each block is for describing an embodiment of the present disclosure, and its specific operation or device does not limit the scope of the present disclosure.

According to another embodiment of the present disclosure, unlike the display device 100 shown in FIG. 1, the display device 100 may receive an image through the network interface 133 or the external device interface 135 without a tuner 131 and a demodulator 132 and play back the same.

For example, the display device 100 may be divided into an image processing device, such as a set-top box, for receiving broadcast signals or content according to various network services, and a content playback device that plays back content input from the image processing device.

In this case, an operation method of the display device according to an embodiment of the present disclosure will be described below may be implemented by not only the display device 100 as described with reference to FIG. 1 and but also one of an image processing device such as the separated set-top box and a content playback device including the display 180 and the speaker 185.

The speaker 185 may receive a signal audio-processed by the controller 170 and output the same with audio.

The power supply circuit 190 may supply corresponding power to the display device 100. Particularly, power may be supplied to the controller 170 that may be implemented in the form of a system on chip (SOC), the display 180 for image display, and the speaker 185 for audio output.

Specifically, the power supply circuit 190 may include a converter that converts AC power into DC power, and a dc/dc converter that converts a level of DC power.

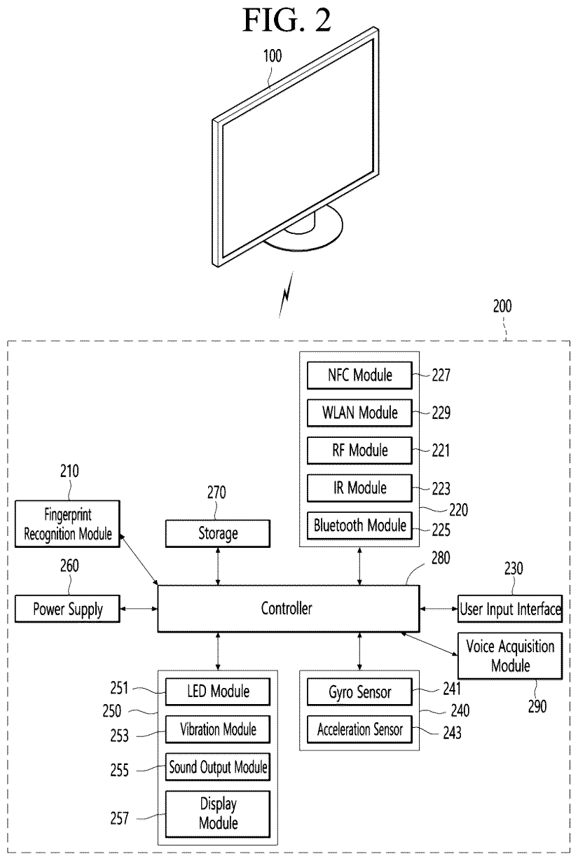

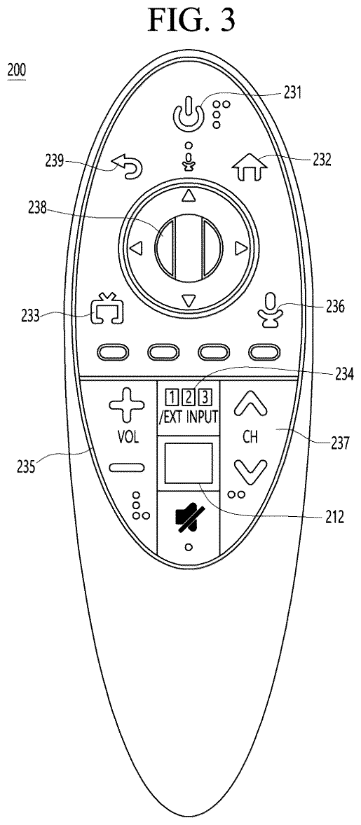

Next, a remote control device according to an embodiment of the present disclosure will be described with reference to FIGS. 2 to 3.

FIG. 2 is a block diagram of a remote control device according to an embodiment of the present disclosure, and FIG. 3 illustrates an actual configuration example of a remote control device 200 according to an embodiment of the present disclosure.

First, referring to FIG. 2, the remote control device 200 may include a fingerprint reader 210, a wireless communication circuit 220, a user input interface 230, a sensor 240, an output interface 250, a power supply circuit 260, a memory 270, a controller 280, and a microphone 290.

Referring to FIG. 2, the wireless communication circuit 220 may transmit and receive signals to and from any one of display devices according to embodiments of the present disclosure described above.

The remote control device 200 may include an RF circuit 221 capable of transmitting and receiving signals to and from the display device 100 according to the RF communication standard, and an IR circuit 223 capable of transmitting and receiving signals to and from the display device 100 according to the IR communication standard. In addition, the remote control device 200 may include a Bluetooth circuit 225 capable of transmitting and receiving signals to and from the display device 100 according to the Bluetooth communication standard. In addition, the remote control device 200 may include an NFC circuit 227 capable of transmitting and receiving signals to and from the display device 100 according to the NFC communication standard, and a WLAN circuit 229 capable of transmitting and receiving signals to and from the display device 100 according to the WLAN communication standard.

In addition, the remote control device 200 may transmit a signal containing information on the movement of the remote control device 200 to the display device 100 through the wireless communication circuit 220.

Meanwhile, the remote control device 200 may receive a signal transmitted by the display device 100 through the RF circuit 221, and transmit a command regarding power on/off, channel change, volume adjustment, or the like to the display device 100 through the IR circuit 223 as necessary.

The user input interface 230 may include a keypad, a button, a touch pad, a touch screen, or the like. The user may input a command related to the display device 100 to the remote control device 200 by operating the user input interface 230. When the user input interface 230 includes a hard key button, the user may input a command related to the display device 100 to the remote control device 200 through a push operation of the hard key button. Details will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back-play button 239.

The fingerprint recognition button 212 may be a button for recognizing a user's fingerprint. In one embodiment, the fingerprint recognition button 212 may enable a push operation, and thus may receive a push operation and a fingerprint recognition operation. The power button 231 may be a button for turning on/off the power of the display device 100. The home button 232 may be a button for moving to the home screen of the display device 100. The live button 233 may be a button for displaying a real-time broadcast program. The external input button 234 may be a button for receiving an external input connected to the display device 100. The volume control button 235 may be a button for adjusting the level of the volume output by the display device 100. The voice recognition button 236 may be a button for receiving a user's voice and recognizing the received voice. The channel change button 237 may be a button for receiving a broadcast signal of a specific broadcast channel. The OK button 238 may be a button for selecting a specific function, and the back-play button 239 may be a button for returning to a previous screen.

A description will be given referring again to FIG. 2.

When the user input interface 230 includes a touch screen, the user may input a command related to the display device 100 to the remote control device 200 by touching a soft key of the touch screen. In addition, the user input interface 230 may include various types of input means that may be operated by a user, such as a scroll key or a jog key, and the present embodiment does not limit the scope of the present disclosure.

The sensor 240 may include a gyro sensor 241 or an acceleration sensor 243, and the gyro sensor 241 may sense information regarding the movement of the remote control device 200.

For example, the gyro sensor 241 may sense information about the operation of the remote control device 200 based on the x, y, and z axes, and the acceleration sensor 243 may sense information about the moving speed of the remote control device 200. Meanwhile, the remote control device 200 may further include a distance measuring sensor to sense the distance between the display device 100 and the display 180.

The output interface 250 may output an image or audio signal corresponding to the operation of the user input interface 230 or a signal transmitted from the display device 100. The user may recognize whether the user input interface 230 is operated or whether the display device 100 is controlled through the output interface 250.

For example, the output interface 450 may include an LED 251 that emits light, a vibrator 253 that generates vibration, a speaker 255 that outputs sound, or a display 257 that outputs an image when the user input interface 230 is operated or a signal is transmitted and received to and from the display device 100 through the wireless communication circuit 220.

In addition, the power supply circuit 260 may supply power to the remote control device 200, and stop power supply when the remote control device 200 has not moved for a predetermined time to reduce power consumption. The power supply circuit 260 may restart power supply when a predetermined key provided in the remote control device 200 is operated.

The memory 270 may store various types of programs and application data required for control or operation of the remote control device 200. When the remote control device 200 transmits and receives signals wirelessly through the display device 100 and the RF circuit 221, the remote control device 200 and the display device 100 transmit and receive signals through a predetermined frequency band.

The controller 280 of the remote control device 200 may store and refer to information on a frequency band capable of wirelessly transmitting and receiving signals to and from the display device 100 paired with the remote control device 200 in the memory 270.

The controller 280 may control all matters related to the control of the remote control device 200. The controller 280 may transmit a signal corresponding to a predetermined key operation of the user input interface 230 or a signal corresponding to the movement of the remote control device 200 sensed by the sensor 240 through the wireless communication circuit 220.

Also, the microphone 290 of the remote control device 200 may obtain voice.

The microphone 290 may include at least one microphone 291 and can acquire voice through the microphone 291.

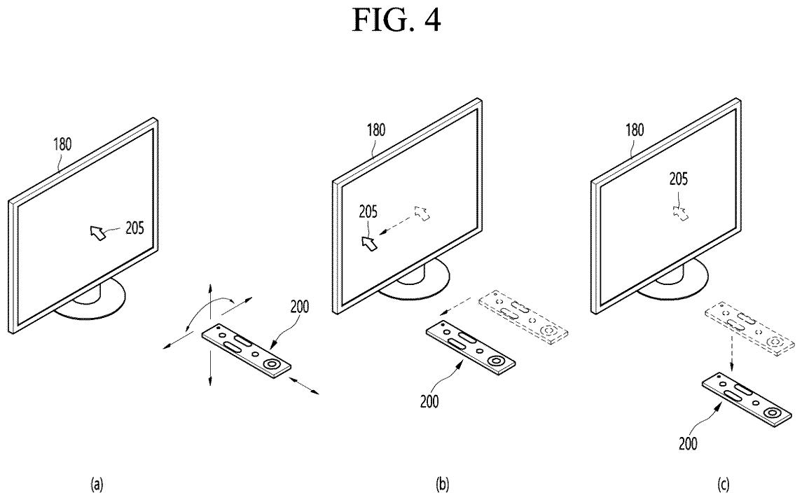

Next, a description will be given referring to FIG. 4.

FIG. 4 illustrates an example of using a remote control device according to an embodiment of the present disclosure.

In (a) of FIG. 4, it is illustrated that a pointer 205 corresponding to the remote control device 200 is displayed on the display 180.

The user may move or rotate the remote control device 200 up, down, left and right. The pointer 205 displayed on the display 180 of the display device 100 may correspond to the movement of the remote control device 200. As shown in the drawings, the pointer 205 is moved and displayed according to movement of the remote control device 200 in a 3D space, so the remote control device 200 may be called a space remote control device.

In (b) of FIG. 4, it is illustrated that that when the user moves the remote control device 200 to the left, the pointer 205 displayed on the display 180 of the display device 100 moves to the left correspondingly.

Information on the movement of the remote control device 200 detected through a sensor of the remote control device 200 is transmitted to the display device 100. The display device 100 may calculate the coordinates of the pointer 205 based on information on the movement of the remote control device 200. The display device 100 may display the pointer 205 to correspond to the calculated coordinates.

In (c) of FIG. 4, it is illustrated that a user moves the remote control device 200 away from the display 180 while pressing a specific button in the remote control device 200. Accordingly, a selected area in the display 180 corresponding to the pointer 205 may be zoomed in and displayed enlarged.

Conversely, when the user moves the remote control device 200 to be close to the display 180, the selected area in the display 180 corresponding to the pointer 205 may be zoomed out and displayed reduced.

On the other hand, when the remote control device 200 moves away from the display 180, the selected area may be zoomed out, and when the remote control device 200 moves to be close to the display 180, the selected area may be zoomed in.

Also, in a state in which a specific button in the remote control device 200 is being pressed, recognition of up, down, left, or right movements may be excluded. That is, when the remote control device 200 moves away from or close to the display 180, the up, down, left, or right movements are not recognized, and the forward and backward movements may be recognized. In a state in which a specific button in the remote control device 200 is not being pressed, the pointer 205 moves according to the up, down, left, or right movements of the remote control device 200.

Meanwhile, the movement speed or the movement direction of the pointer 205 may correspond to the movement speed or the movement direction of the remote control device 200.

Meanwhile, in the present specification, a pointer refers to an object displayed on the display 180 in response to an operation of the remote control device 200. Accordingly, objects of various shapes other than the arrow shape shown in the drawings are possible as the pointer 205. For example, the object may be a concept including a dot, a cursor, a prompt, a thick outline, and the like. In addition, the pointer 205 may be displayed corresponding to any one point among points on a horizontal axis and a vertical axis on the display 180, and may also be displayed corresponding to a plurality of points such as a line and a surface.

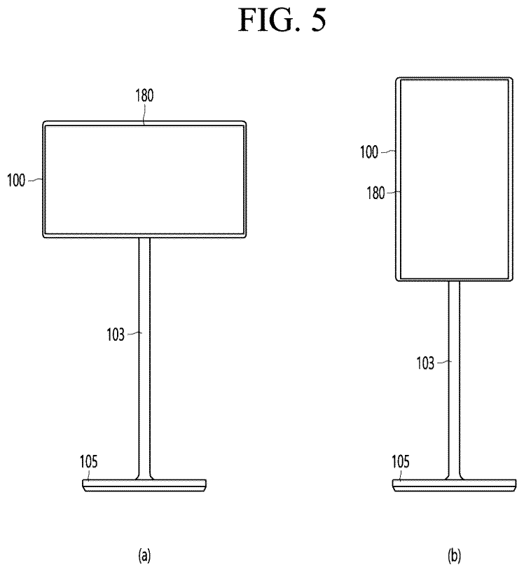

(a) and (b) of FIG. 5 are diagrams for describing a horizontal mode and a vertical mode of a stand-type display device according to an embodiment of the present disclosure.

Referring to (a) and (b) of FIG. 5, a stand-type display device 100 is illustrated.

A shaft 103 and a stand base 105 may be connected to the display device 100.

The shaft 103 may connect the display device 100 and the stand base 105 to each other. The shaft 103 may extend vertically.

The lower end of the shaft 103 may be connected to the edges of the stand base 105.

The lower end of the shaft 103 may be rotatably connected to the edges of the stand base 105.

The display device 100 and the shaft 103 may rotate about a vertical axis with respect to the stand base 105.

An upper portion of the shaft 103 may be connected to the rear surface of the display device 100.

The stand base 105 may serve to support the display device 100.

The display device 100 may be configured to include the shaft 103 and the stand base 105.

The display device 100 may rotate around a point where the upper portion of the shaft 103 and the rear surface of the display 180 contact each other.

(a) of FIG. 5 illustrates that the display 180 operates in a landscape mode in which the horizontal length is greater than the vertical length, and (b) of FIG. 5 illustrates that the display 180 operates in a portrait mode in which the vertical length is greater than the horizontal length.

A user may move while holding a stand-type display device. That is, the stand-type display device has improved mobility, unlike a fixed device, so that a user is not limited by an arrangement position.

Next, a method of adaptively processing a video (or an image) according to data reception conditions in the display device 100 through a network will be described. In this context, the term ‘adaptive processing’ may be exemplified by smoothly handling changes in the displayed video—that is, the output—in a way that minimizes or eliminates any discomfort for the viewer. This ensures a seamless viewing experience for the user.

In the following sections, various embodiments of video processing methods for the display device (100) are disclosed, but are not limited thereto.

The advancement of multimedia technology has made it possible to enjoy video content anytime, anywhere. However, this has led to a significant surge in the amount of data required for such content. As a result, the display device 100, which demands high performance for this purpose, might encounter situations where the smooth delivery of video to users is compromised due to poor data reception concerning the content, depending on the surrounding conditions.

In addressing these issues, the introduction of Quality of Service (QoS) technology has been pivotal. The QoS technology involves dynamically calibrating the video quality level presented by the display device 100 based on the currently available data reception capacity. This technique also encompasses adapting the necessary data volume required by the display device 100 in response to varying conditions. Thus, the display device 100 may effectively manage situations where video interruptions caused by insufficient video data are prevented, even in challenging data reception conditions, even if this entails a reduction in the video quality level. Examples of such QoS technologies encompass adaptive bitrate streaming utilized in network-based content delivery services like Over the Top (OTT) and Video on Demand (VoD), along with scalable High Efficiency Video Coding (HEVC) employed in ATSC 3.0 broadcasting.”

The majority of QoS technologies provide support for seamless transitions, ensuring that, during content playback, there is no occurrence of visual glitches or interruptions when adjusting the video quality level. However, altering the quality level of video content itself may be discernible to users, leading to a sense of artificiality. For instance, when a user is streaming an online video in a public area, it may be common for the video quality to suffer due to network constraints, leading to occurrences like video blurring or a reduction in video resolution. In adaptive bitrate streaming scenarios, even under favorable network conditions, the inherent behavior often involves initially delivering lower-quality video content during the early stages of stream playback, followed by subsequent enhancements. However, this might be perceived as a decline in service quality by users who are already accustomed to top-notch video content, given the intense competition among Content Providers (CPs).

In the following sections, the present disclosure introduces an approach to mitigate the discomfort experienced by users based on their perception of changes in the quality level of videos provided for content where the QoS technology has been applied.

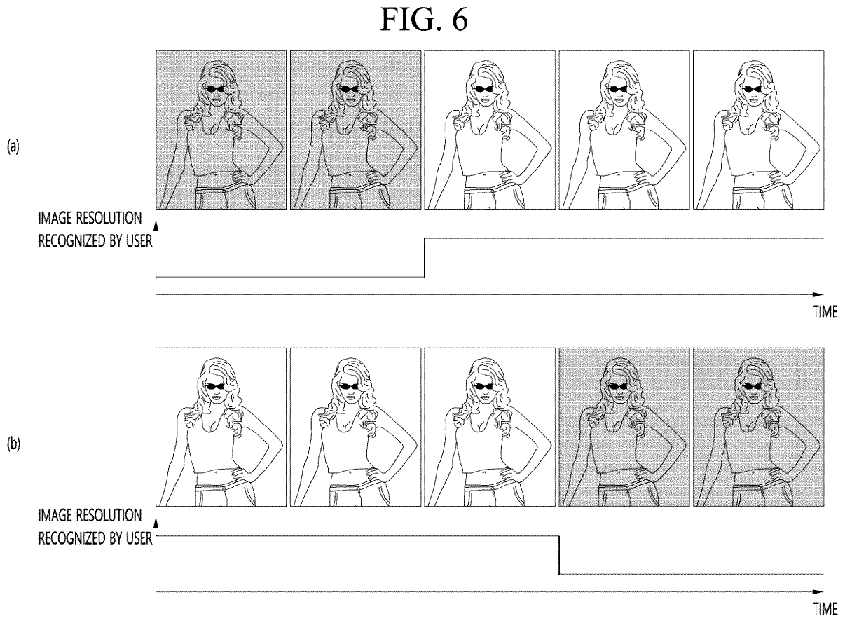

FIG. 6 is a diagram illustrating a video processing method of the display device 100 based on changes in data reception conditions.

As described above, when the data reception situation changes, the display device 100 may immediately provide processed data corresponding to the changed data reception situation.

Referring to (a) of FIG. 6, if the data reception situation improves, resulting in the reception of a higher-resolution video compared to before, the display device 100 may provide content with an instantly heightened resolution to a user. On the other hand, referring to (b) of FIG. 6, if the data reception situation worsens, leading to the reception of a lower-resolution video compared to before, the display device 100 may provide content with an immediately diminished resolution to a user. In the scenarios depicted in (a) or (b) of FIG. 6, as mentioned earlier, it is highly possible that a user will promptly notice any alteration in the video quality of the content being displayed through the display device 100.

Therefore, the present disclosure is to process such shifts in video quality in response to data reception conditions, as naturally as possible from the user's perspective, as described in the aforementioned scenarios.

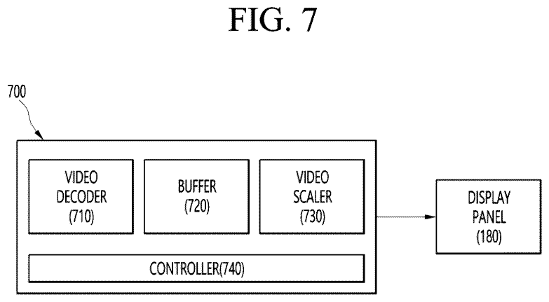

FIG. 7 is a diagram illustrating the configuration of a display device 100 that seamlessly handles video processing in response to changes in data reception conditions, according to an embodiment of the present disclosure.

The display device 100 according to the present disclosure may encompass components such as a video decoder, a display for video output, and a processor that controls video decoder. In this scenario, the processor may be to control changes in resolution for at least one second video frame adjacent to the first video frame, when a first video frame with a resolution differing from the previous frame (or to be displayed through the display at a different resolution) is identified among the video frames decoded by the video decoder. Meanwhile, the processor may manage the resolution change through a preconfigured adjustment of video quality factors for the first and second video frames. These quality factors might encompass sharpness adjustments.

Referring to FIG. 7, the display device 100 may include a processor 700 for video processing and a display panel 180.

In this case, the processor 700 may incorporate elements like a video decoder 710, a buffer 720, a video scaler 730, and a controller 740.

The processor 700 might be realized in the form of a System on Chip (SoC). Such a processor 700 or a controller 740 may include or be a timing controller (T-con).

The video decoder 710 is capable of decoding the video data of the received content.

The buffer 720 may temporarily store decoded video frames. In accordance with an example, the buffer 720 might be incorporated as a functional element within the video decoder 710 rather than existing as an independent component. Furthermore, the presence of multiple buffers 720 is plausible, not limited to just one.

The video scaler 730 is capable of adjusting video quality, such as modifying resolution, by scaling decoded video frames.

The controller 740 may oversee the operation of individual components for video processing in accordance with the conditions of data reception.

A more detailed explanation of the operation of the components depicted in FIG. 7 will be provided later.

In the following sections, a sequential explanation of methods, including frame-by-frame processing, scene change processing, and considering frequency components that constitute a video, will be described in response to changes in data reception conditions.

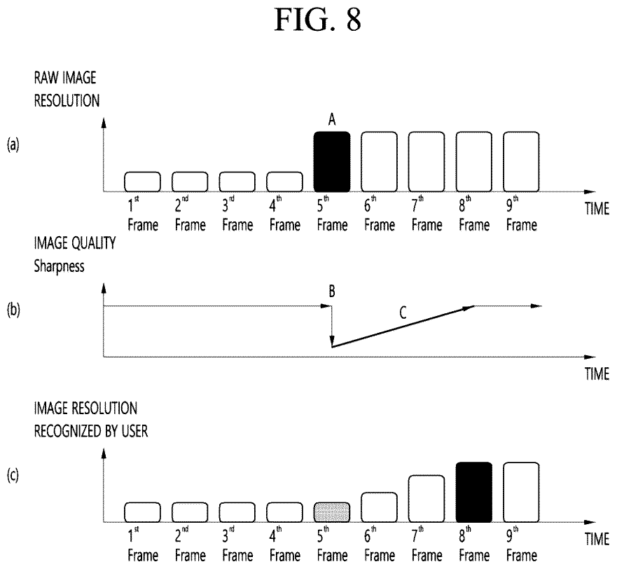

FIGS. 8 to 10 are diagrams illustrating the operation of the display device 100.

FIGS. 8 to 10 may illustrate the content processing method according to the present disclosure, particularly in cases where the data reception situation improves from a certain point in time.

(a) of FIG. 8 is a diagram that illustrates the alteration in the original resolution of a video being displayed by the display device 100 in response to a change in data reception conditions. (b) of FIG. 8 is a diagram illustrating the shift in video quality factors in the mentioned scenario according to the present disclosure. (c) of FIG. 8 is a diagram illustrating the change in user resolution corresponding to (b) of FIG. 8 and the present disclosure. In the graph presented in (a) of FIG. 8, the vertical axis could represent, for instance, the native resolution of video frames conveyed from the video decoder 710 through the buffer 720 to the video scaler 730. Alternatively, in the graph displayed in (a) of FIG. 8, the horizontal axis might depict the time when video frames are output through the display panel 180 of the display device 100.

In the present disclosure, sharpness is presented as an illustrative example of a video quality factor that is referenced for video processing in response to changes in data reception conditions. In other words, there could be at least one or more alternative factors that influence video quality, which could either replace sharpness or work in conjunction with it as part of the video quality factor.

More specifically, referring to (a) of FIG. 8, when the data reception situation improves, starting from point A, which corresponds to the 5th frame, the display device 100 may output a video with higher resolution in comparison to the previous content.

During such instances, when the display device 100 may present a high-resolution video on the screen, similar to scenario A depicted in (a) of FIG. 8, the sharpness, as illustrated in (b) of FIG. 8, may be promptly reduced. As a result, as indicated in (c) of FIG. 8, the user can perceive that there is minimal or negligible alteration in the resolution of the 5th frame compared to the preceding frame (4th frame).

Subsequently, the display device 100 may gradually restore the sharpness back to its original value in the 8th frame. This restoration process may be managed in a manner similar to what is depicted in (c) of FIG. 8, where the sharpness between the 5th and 8th frames is recuperated. Consequently, as depicted in (c) of FIG. 8, the gradual alteration in video resolution from the 5th frame onwards is not readily noticeable to the user.

In the context mentioned above, a level of the change above may be determined based on arbitrary values, either in response to a user's request or by configuring the display device 100.

While not explicitly outlined in this specification, it is possible to exert control in a manner that follows a certain slope, rather than an immediate application, akin to the approach depicted in B shown in (b) of FIG. 8.

In (b) of FIG. 8, specifically in segment C, the display device 100 may ascertain the difference in the original resolution of the video before and after the alteration in data reception situation, as the decoded video frame is fed into the buffer 720. Utilizing this discrepancy as a foundation, the device can then decide upon the degree by which the sharpness value should be adjusted, considering the slope. As an example, when the resolution alteration is minor, a significant slope value may be chosen. Conversely, if the resolution change is substantial, a smaller slope value could be opted for, although the reverse might also apply.

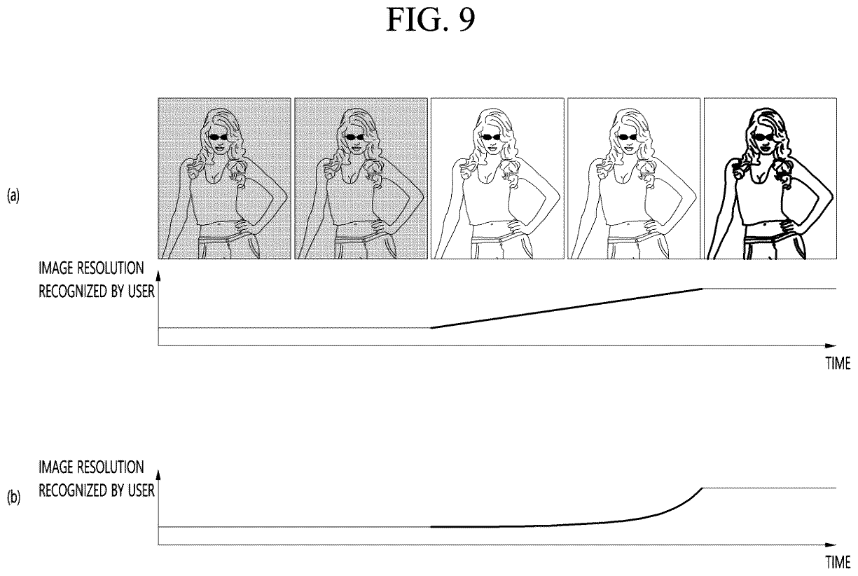

Referring to (a) of FIG. 9, as the user perceives an incremental enhancement in video resolution akin to the situation depicted in FIG. 8, the probability of them discerning changes in video quality diminishes relatively. Consequently, the alteration in video quality might not feel unnatural, despite alterations in data reception conditions.

Conversely, taking into account the cognitive attributes of the average person, the display device 100 may also regulate the temporal resolution change in the manner of a gamma curve, as depicted in (b) of FIG. 9. In contrast, (b) of FIG. 9, similar to the cases in FIG. 8 and (a) of FIG. 9, depicts a scenario where video quality is enhanced. Therefore, in the opposite scenario, the gamma curve might adjust accordingly.

In addition, the display device 100 may analyze the video through pre-processing of the video data stored in the buffer 720. Based on the analysis results, the display device 100 may detect regions of interest (RoIs) set by the user or the device itself, such as ‘character's faces’, within the video. The display device 100 may manage the application of different sharpness levels to the detected Regions of Interest (RoIs) and other areas. In this scenario, the RoI may represent the region or area where an object is situated. Moreover, the object may encompass individuals, specific body parts of individuals (such as faces, hands, etc.), objects, or portions of objects, among other possibilities.

On the other hand, the Region of Interest (RoI) is not strictly confined to the area where the object is situated. For example, at least a part of the surrounding area may also be set as the RoI. At this time, to set the RoI, the display device 100 may determine it referring to the relationship between the surrounding region and the corresponding object.

When different types of sharpness or sharpness curves are applied to the above-mentioned RoI and other regions, first change the resolution of a part other than the face, and then change the RoI. That is, by changing the resolution of the face part, it is possible to reduce the user's resistance to the change in video quality by seamlessly processing the change in the region of interest such as a character to be natural.

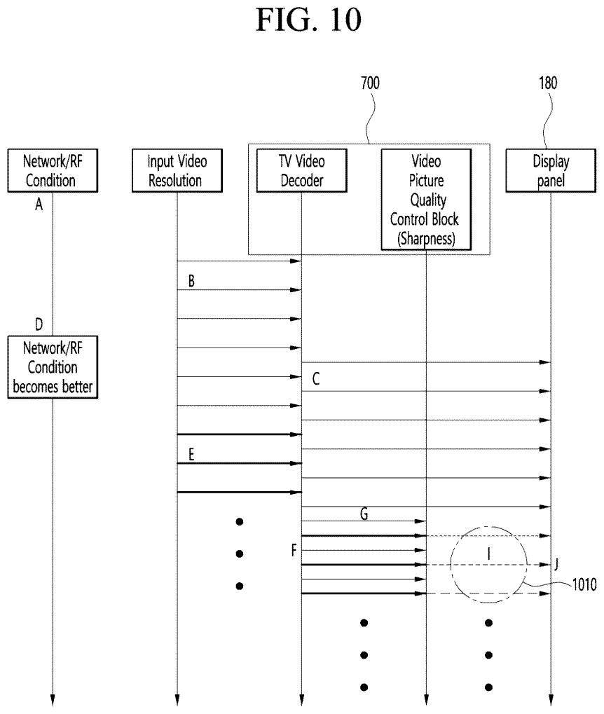

FIG. 10 illustrates an operation sequence diagram of the display device 100.

In FIG. 10, the depicted scenario illustrates a situation where the data reception condition, specifically the network/RF signal condition, transitions from a poor state to an improved state, as demonstrated in A.

In scenario B, where the network/RF signal condition remains poor (i.e., no change), the display device 100 may continue to receive a low-resolution video signal. The video decoder 710 may decode the low-resolution video signal and then transmit the decoded low-resolution video to the display panel 180, resulting in output similar to scenario C.

From point D, when the network/RF signal conditions improve, the display device 100 may receive a higher-resolution video signal compared to the previous state, as depicted in scenario E. As a result, the video decoder 710 may decode the video signal with higher resolution compared to the previous one, and transmit the decoded higher-resolution video to the display panel 180, resulting in output as depicted in scenario F.

In this scenario, the video decoder 710 according to the present disclosure may control the signal G corresponding to the pixel quality (PQ) sharpness at time point F, when the higher-resolution video compared to the previous one is being transmitted to the display panel 180. This control may prevent the immediate improvement of video resolution.

Subsequently, by gradually increasing the signal G corresponding to sharpness, as shown in 1010, the resolution of the video transmitted from the video decoder 710 to the display panel 180 may remain unchanged from the previous state at point I and gradually improve over time. Therefore, as the video resolution perceptible by the user gradually improves from point J, it becomes possible to minimize the likelihood of the user perceiving any unnaturalness in the change of video quality.

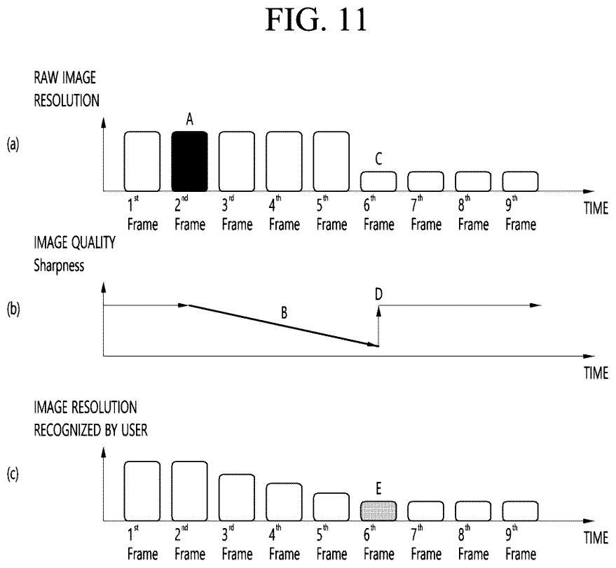

FIGS. 11 to 13 are diagrams for explaining the operation of the display device 100.

FIGS. 11 to 13 represent the opposite scenario to the earlier FIGS. 8 to 10, illustrating a situation where the data reception conditions transition from a good state to a poor state.

As depicted in (a) of FIG. 11, when the data reception conditions worsen, the display device 100 may receive a video signal with a lower resolution compared to the previous state.

In this scenario, in accordance with the present disclosure, the display device 100 does not adjust the sharpness to transition from high-resolution video to low-resolution video at the moment when the 6th frame is displayed. Instead, it may proactively control the sharpness adjustment starting from the frames preceding that specific frame.

On the other hand, the display device 100 may identify a starting point A (for instance, refer to (a) of FIG. 11) for sharpness adjustment based on the sharpness slope B. Alternatively, the display device 100 may calculate the time difference between time point A in (a) of FIG. 11 and the time point at which the low-resolution video should be displayed, which is time point C in (a) of FIG. 11.

Subsequently, within that period, the display device 100 may be controlled to gradually reduce the sharpness of the video quality in sequence, for instance, following a slope B depicted in (b) of FIG. 11. As the display device 100 is aware of the difference in the original video resolution before and after the deterioration of the data reception situation, it may decide how much to decrease the sharpness of the video quality using a particular slope, such as the one illustrated in (b) of FIG. 11 (for instance, B as shown in (b) of FIG. 11).

Hence, as depicted in (c) of FIG. 11, the change in video resolution perceived by the user at time point E (6th frame), corresponding to time point C illustrated in (a) of FIG. 11, is controlled to occur gradually from the 3rd frame. This control ensures that the user perceives the altered resolution at time point E in a gradual manner, rather than experiencing a sudden shift in resolution.

At the time point C indicated in (a) of FIG. 11, which corresponds to the moment when a video with a low original resolution needs to be displayed on the screen, the sharpness can be instantly restored to its original value, as shown in D depicted in (b) of FIG. 11. However, in this scenario, even if the video quality sharpness is restored instantly at time point D in (b) of FIG. 11, the perceived video resolution at that point onward might not exhibit a significant or noticeable difference compared to the previous video frame due to the lower original resolution of the video.

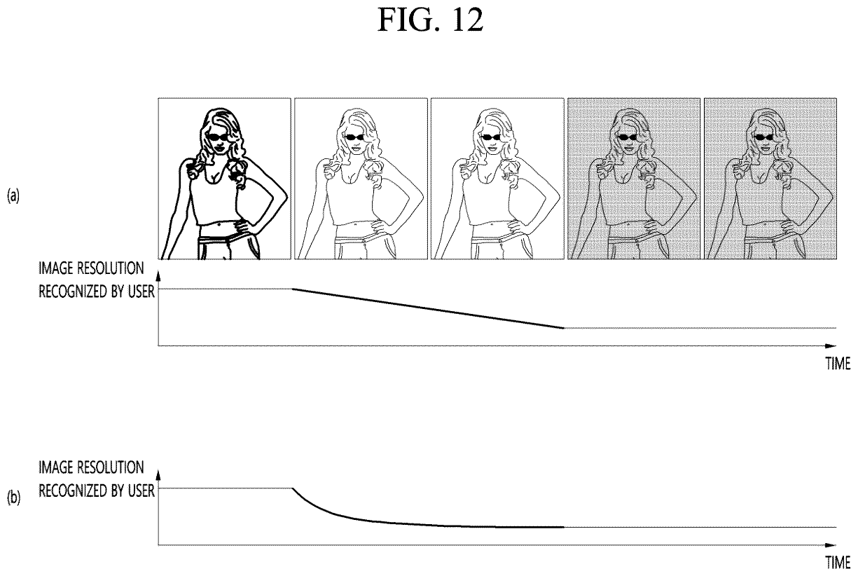

As depicted in (a) of FIG. 12, by gradually altering the user-perceived video resolution using a predetermined gradient, the likelihood of the user noticing such changes may be diminished.

In comparison to (b) of FIG. 9, it is evident that a distinct sharpness gamma curve is employed in (b) of FIG. 12 due to deteriorating data reception conditions or circumstances.

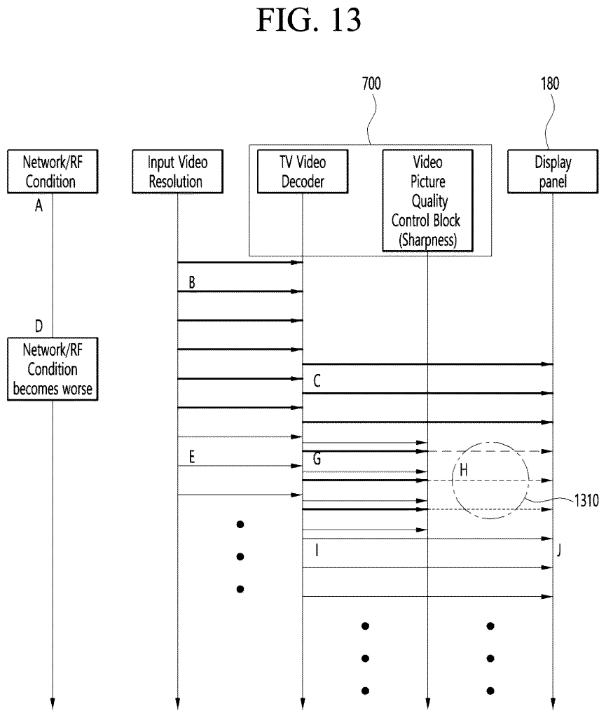

In FIG. 13, an operation sequence diagram depicting the operational sequence of a display device 100 based on another embodiment of the present disclosure is presented.

In FIG. 13, the scenario where the network/RF signal condition changes from a good state to a bad state is illustrated, as depicted in A.

In scenario B, the display device 100 is capable of receiving a high-resolution video signal. The video decoder 710 may decode the high-resolution video signal and transmit it to the display panel 180 for output, as illustrated in C.

When the network/RF signal condition deteriorates starting from point D, the display device 100 is capable of receiving a video signal with a lower resolution compared to the previous one, as depicted in E.

However, point E corresponds to a period during which the video decoder 710 continues transmitting high-resolution videos such as C and G to the display panel 180. Thus, by gradually decreasing the value of G associated with the sharpness control signal at that moment, the resolution of the video at point H transmitted to the display panel 180 can also be progressively reduced, similar to 1310.

At the time point I, when the video decoder 710 changes the original resolution of the video transmitted to the display panel 180 from high resolution to low resolution, it can instantly restore the gradually decreased sharpness value to its original value. However, despite this, the decreased original video resolution and the increased sharpness can offset each other, resulting in a perception from the user's perspective that there is no change in video resolution.

As the user perception resolution gradually decreases prior to point J, when the original resolution of the video displayed on the display panel changes from high resolution to low resolution, the user's likelihood of perceiving unnaturalness due to such a change in video quality can be minimized.

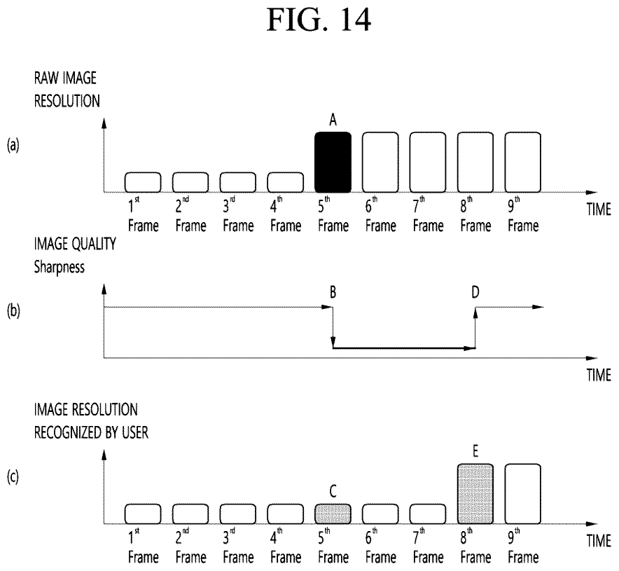

FIGS. 14 to 16 are diagrams for explaining the operation of the display device 100.

In each of the embodiments described in FIGS. 8 to 10 and 11 to 13, a disclosed embodiment of processing at the frame level has been presented to minimize the perception of unnaturalness to the user in response to changes in the data reception environment.

In this context, it's possible for the mentioned embodiment to include frames corresponding to scene changes among the target frames.

On the contrary, moving forward, a method will be presented for minimizing the potential perception of unnaturalness by processing on a scene change unit basis, rather than a frame unit basis, in response to changes in the data reception environment.

In the context of the present disclosure, scene change detection can be referenced from existing technologies. Scene change detection can take place within the decoded picture buffer 720 of the video decoder 710. The buffer 720 stores video frames that have completed decoding and are awaiting output to a display. Therefore, by applying the scene change detection algorithm to the video frames in the buffer 720 that are in a waiting state, it is possible to pre-determine whether scene changes occur in the target video frames.

In (a) of FIG. 14, the display device 100 may output a high-resolution video on the screen from point A when a higher-resolution video than the previous one is received because the data reception situation is improved.

At this moment, the display device 100 may instantaneously reduce the video quality sharpness value at time B shown in (b) of FIG. 14, in order to control the video resolution perceived by the user at time C shown in (c) of FIG. 14 so that it is intentionally not improved.

Subsequently, the video is analyzed on a frame-by-frame basis, allowing for an instantaneous restoration of the original sharpness value at the moment marked as point D in FIG. 14, as depicted in (c) of FIG. 14, thereby facilitating an immediate enhancement of the user's perceived video resolution. In this case, the mentioned point D could correspond to the frame associated with a scene change.

The user's perception of changes in video resolution due to scene changes decreases relatively, resulting in a smoother transition of video resolution improvement without feeling unnatural.

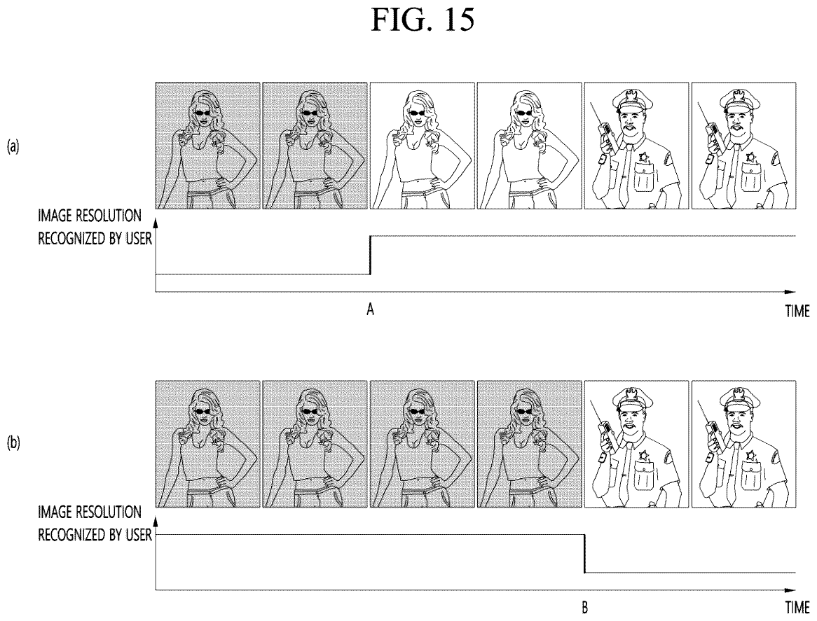

As depicted in A in (a) of FIG. 15, the video resolution improvement could be easily noticed by the user within a single scene. However, in the present disclosure, by enabling an instantaneous enhancement of the user-perceived video resolution at the moment of a scene change, as shown in B of (b) in FIG. 15, the improvement in video resolution can be controlled in such a way that it is not easily perceptible to the user.

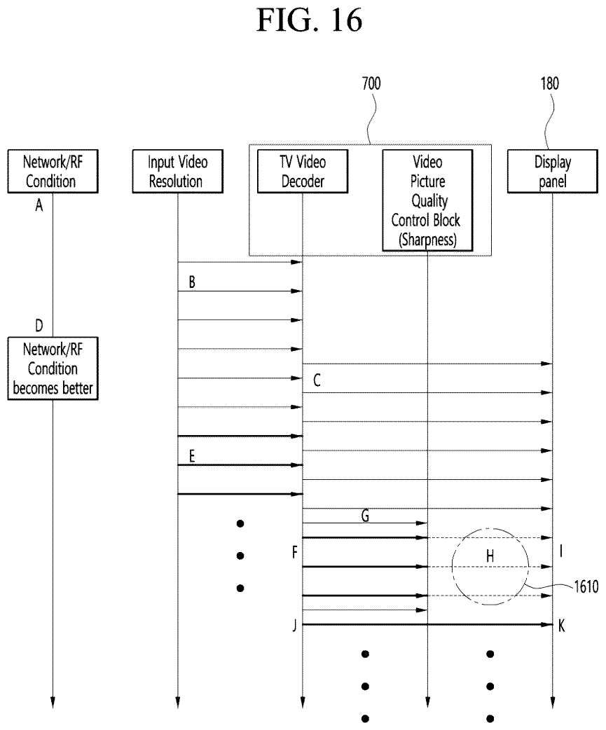

FIG. 16 illustrates an operation sequence diagram of a display device 100 according to another embodiment of the present disclosure.

In FIG. 16, first, as shown in A, the case where the network/RF signal condition is improved from a bad state to a good state is shown.

For scenario B, since the network/RF signal condition remains poor, the display device 100 receives a low-resolution video signal. The video decoder 710 decodes the video signal, as illustrated in C, and transmits the low-resolution video to the display panel 180 for output.

From point D onward, when the network/RF signal condition improves, transitioning to a good state, the display device 100 can receive a higher-resolution video signal than before, as illustrated in point E.

The video decoder 710 can decode the video signal, allowing a high-resolution video, as depicted in point F, to be transmitted to the display panel 180 for output.

In accordance with the present disclosure, the video decoder 710 can regulate a signal G corresponding to the sharpness of PQ at time point F, where a higher-resolution video is sent to the display panel 180. This control prevents an immediate enhancement of the user-perceived video resolution.

As in 1610, the video decoder 710 may control resolution not to be improved even at time points H and I, and display a high-resolution video rather than a low-resolution video on the display panel 180 at time K (e.g., a scene change time).

In the above, the display device 100 may detect a scene change time or a frame position through a scene change detector in the buffer 720 or may detect a scene change in the video decoder 710 itself. That is, the display device 100 may restore the previously degraded sharpness to its original value at the scene change point, that is, at point J, at once.

Therefore, since the display panel 180 outputs a frame having a changed resolution at the K time point, that is, at the scene change time, service may be provided to minimize the possibility of the user recognizing the video change according to the scene change and resolution change performed together.

As shown, the display device 100 may perform stand-by control so that the quality of the output video, that is, the resolution, does not change before the scene change at time point K, despite the change in the data reception situation.

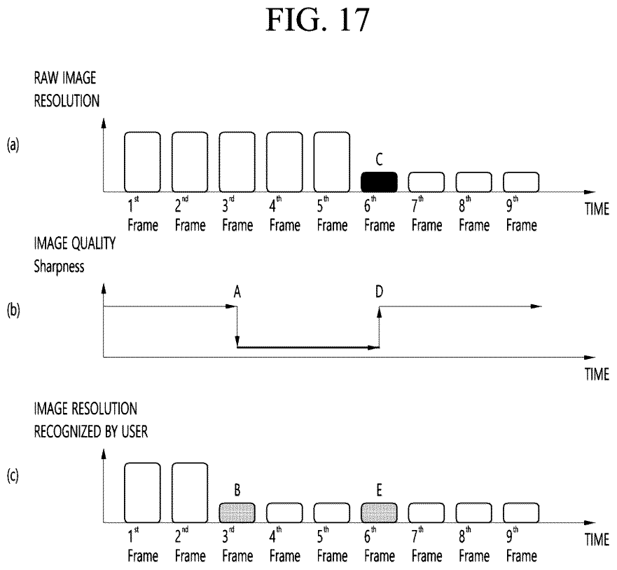

FIGS. 17 to 19 are diagrams illustrating the operation of the display device 100.

In contrast to FIGS. 14 to 16 as described above, in FIGS. 17 to 19, the operation of the display device 100 may start when the data reception situation deteriorates from a good situation to a bad situation.

Referring to (a) of FIG. 17, the display device 100 may determine a point in time to output the low-resolution video when a low-resolution video compared to the previous one is received, as shown in point C, due to a deteriorating data reception situation.

The display device 100 calculates the low-resolution video output time, and instantly lowers the sharpness value as shown in point A shown in (b) of FIG. 17. The video resolution perceived by the user may be lowered as shown in point B shown in (c) of FIG. 17.

Therefore, it might be difficult for the user to easily recognize the scene change and the video quality change at the same time.

When the display device 100 reaches the position C depicted in (a) of FIG. 17, which corresponds to the moment of transmitting the low-resolution video, the display device 100 can temporarily enhance the sharpness, as illustrated at point D in (b) of FIG. 17. On the other hand, since the resolution of the original video is already low at that point in time, there is no change in resolution compared to the previous video frame E shown in (c) of FIG. 17.

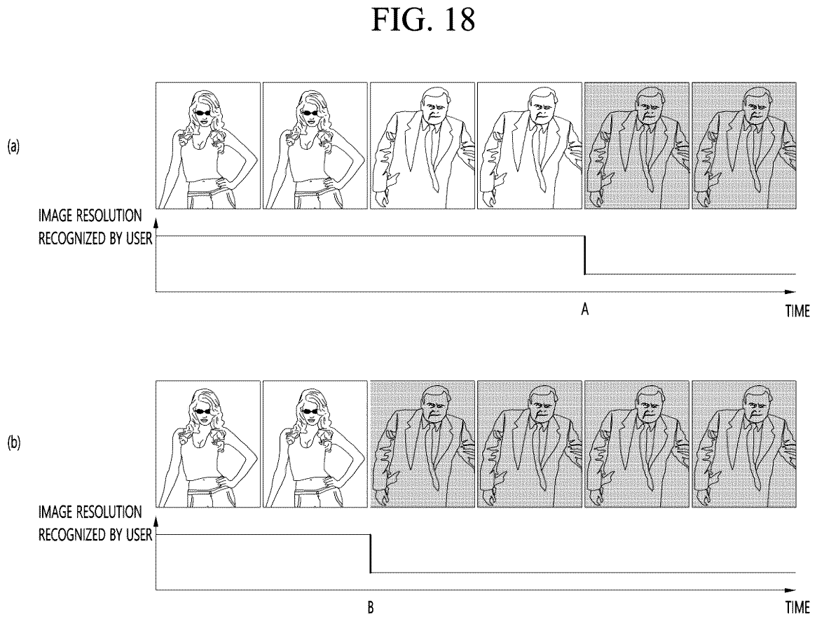

When the display device 100 may process so that the video resolution is lowered at the time point A shown in (a) of FIG. 18, that is, the video quality is changed before the scene change, relatively, it is possible to improve the user's satisfaction with the display device 100 by reducing the user's possibility of recognizing the change in video quality by changing the video quality at the time point B, that is, the scene change time.

On the other hand, in the present disclosure, when a resolution needs to be changed according to a change in the data reception situation in the middle of one scene, as in the case of point A shown in (a) of FIG. 18. It is not limited to controlling the resolution change in advance at the time of change. For example, the display device 100 may detect at least two scene change points adjacent to a resolution change point in time, and then change the resolution at the nearest scene change point in time. Alternatively, the display device 100 may derive a relationship between the at least two or more scene change points, select an appropriate scene change point based on the derived relationship, and change the resolution. At this time, the selected scene change time may not necessarily be limited to the nearest scene change time. Meanwhile, the relationship may indicate, for example, whether a feature or main object is extracted from a frame at a time when a resolution needs to be changed, and whether or not the extracted feature or object is changed or related. A scene change time when the feature or object extracted based on the relationship is changed may be selected as the resolution change scene change time. In the above process, the display device 100 may continue to control the sharpness so that the resolution of output frames is the same as before or gradually changes until at least a desired scene change point, despite a change in data reception conditions.

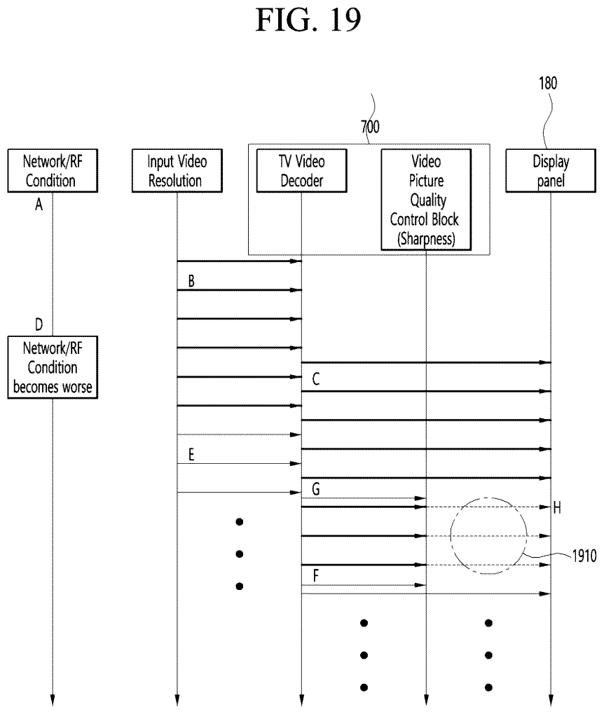

FIG. 19 illustrates an operation sequence diagram of a display device 100.

In FIG. 19, first, as shown in point A, the case where the network/RF signal condition may deteriorate from a good situation to a bad situation is shown.

In the case of B, the display device 100 may receive a high-resolution video signal because the network/RF signal condition is still good, and the video decoder 710 may decode the video signal to display a high-resolution video as shown in point C to the display panel 180 to be output.

When the network/RF signal situation deteriorates from point D to a bad situation, the display device 100 may receive a video signal having a lower resolution compared to the previous one, as shown in time point E. Time point E may be a period in which the video decoder 710 still transmits a high-resolution video to the display panel 180, such as time point C.

For example, at time point E, the video decoder 710 (buffer 730) may know time point F at which a low-resolution video is supplied to the display panel 180.

Accordingly, the video decoder 710 may detect a scene change point that first arrives between time points E and F, and lowers the sharpness value at once, such as time point G, at the point in time to obtain a video perceived by the user. The resolution may be controlled to decrease at once.

Therefore, the video resolution perceived by the user is also reduced at the same time through the rapid decrease in sharpness, but the corresponding moment overlaps with the scene change time, which may prevent the user from easily recognizing such a change. That is, it is difficult for the user to easily recognize the resolution change.

Thereafter, the video decoder 710 may raise the lowered sharpness at once and restore it to its original state at time point F when a lower resolution video is transmitted to the display panel 180, thereby reducing the original resolution and increasing the sharpness. These cancel each other out, so there is no change in the video resolution perceived by the user.

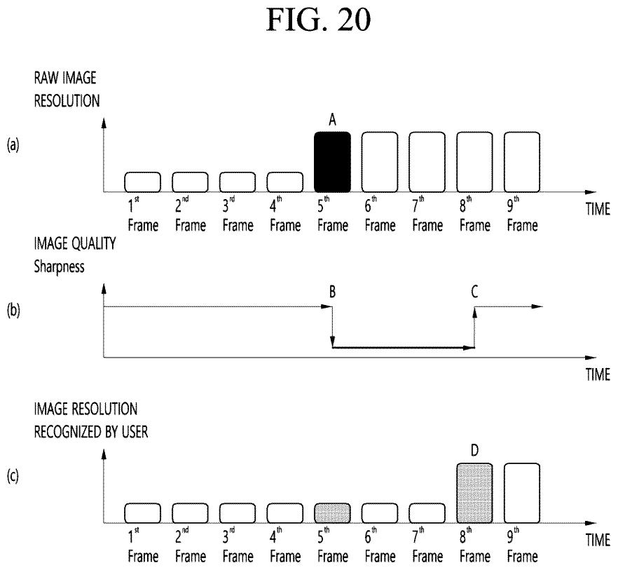

FIGS. 20 to 22 are diagrams illustrating the operation of the display device 100.

The video quality may be controlled by referring to the frequency component of the video according to the change in the data reception environment.

Referring to (a) of FIG. 20, the display device 100 may receive a higher-resolution video compared to the previous one when the data reception situation improves from a bad situation to a good situation from the fifth frame.

A high-resolution video may be output on the screen at a point in time point A shown in (a) of FIG. 20. It may be controlled so that the video resolution perceived by the user is not yet improved by lowering it at once.

Thereafter, the display device 100 may analyze the video frame by frame, and the scene change point at which the video with a small number of high-frequency components is changed to a video with a large number of high-frequency components, that is, at time point C shown in (b) of FIG. 20, the degraded by restoring the sharpness to its original value at once, it is possible to control the video resolution perceived by the user to be improved at once as shown in time point D as shown in (c) of FIG. 20.

Therefore, it is relatively difficult for the user to easily perceive the change in video resolution due to the transition to a scene with a lot of high-frequency components, since the corresponding point in time is the moment when a video with low high-frequency components is changed to a video with high-frequency components.

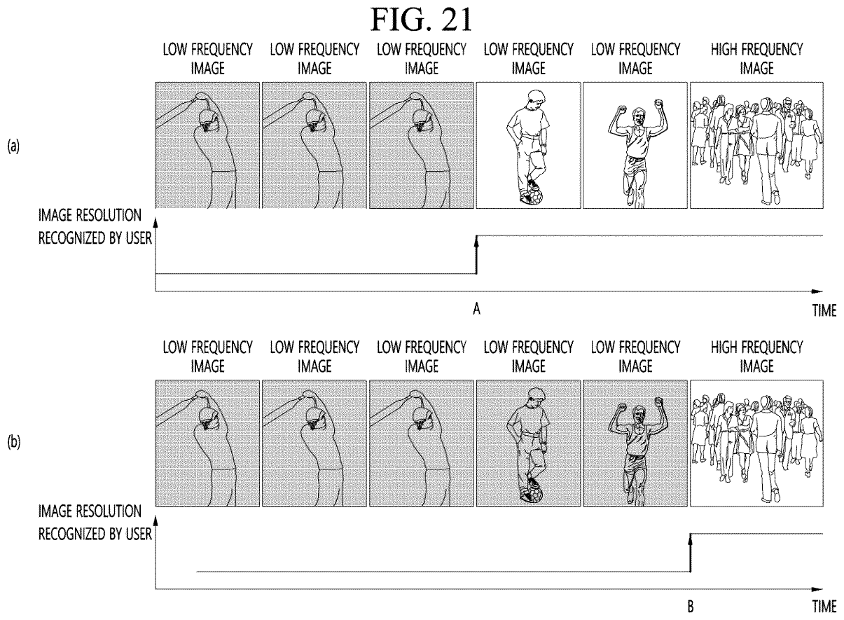

As shown in (a) of FIG. 21, when the video resolution is changed in a scene with a small number of high-frequency components or a large number of low-frequency components, the user may easily recognize this.

Therefore, in the present disclosure, as shown in (b) of FIG. 21, at the moment of scene change from a scene with a small number of high-frequency components to a scene with many scenes, the video resolution perceived by the user is improved at once, thereby increasing the resolution of the video. Changes may be controlled so that users cannot easily perceive them.

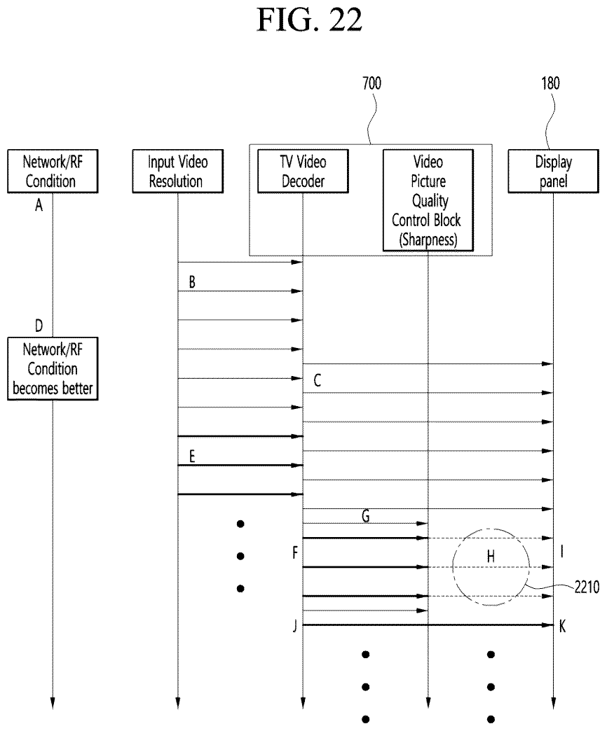

In FIG. 22, an operation sequence diagram of a display device 100 is shown.

In FIG. 22, the case where the network/RF signal condition is improved from a bad situation to a good situation is shown as shown in time point A.

In case B, the display device 100 receives a low-resolution video signal.

The video decoder 710 may decode the video signal and still transmit the low-resolution video to the display panel 180 even at time point C.

In case the network/RF signal condition improves to a good state from time point D, the display device 100 may receive a video signal with a higher resolution compared to the previous one at time E, and the video decoder 710 may decode the video signal at time point F. A high-resolution video may be transmitted to and output from the display panel 180.

However, in case the video decoder 710 transmits a high-resolution video compared to the previous one to the display panel 180 at time point F, the sharpness (G) of the PQ for the video is lowered at once, so that the video resolution perceived by the user is reduced.

At time point I, the video signal input to the display panel 180 may be changed from a low-resolution video to a high-resolution video, but since the sharpness has already been reduced, the video resolution perceived by the user is not changed or improved.

As described above, the buffer 720 may detect a time point of a scene change from temporarily stored frames. The video decoder 710 may detect frequency information (or frequency components) of a video to be decoded. Accordingly, the display device 100 may detect a time point at which a frequency component is changed from a time point of a scene change. The display device 100 may control video quality, that is, resolution to be changed in accordance with that time point. Among the time points of the scene change, the sharpness that was previously lowered at time point J, which is the point of scene change when switching from a low-frequency band scene to a high-frequency band scene, may be controlled to instantly increase (e.g., to an original value).

Referring to FIG. 22, the video resolution is rapidly improved on the display panel 180 at a point in time point K, and this point coincides with the point in time of scene change from a low-frequency scene to a high-frequency scene, overlapping with a point in time when the video itself changes rapidly. From the user's point of view, since the rapid change of the video (e.g., from low frequency to high frequency) and video resolution improvement are performed together, perception of such a change in video quality and feeling of unnaturalness may be relatively low compared to the prior art.

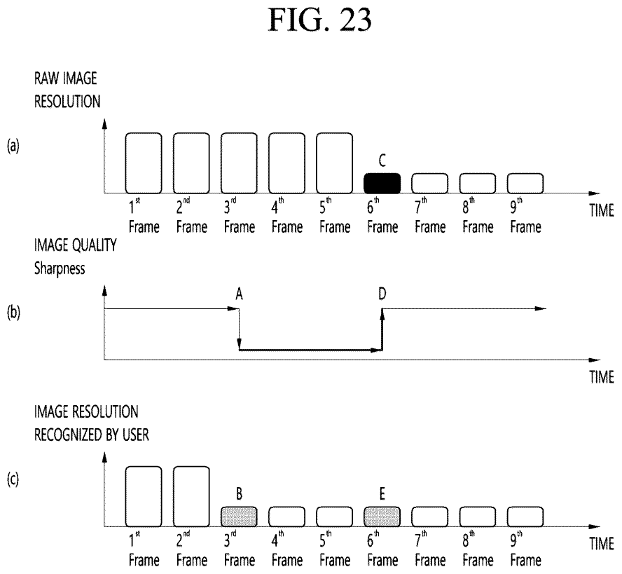

FIGS. 23 to 25 are diagrams illustrating the operation of the display device 100.

Unlike FIGS. 20 to 22, FIGS. 23 to 25 are examples of cases in which the data reception environment deteriorates from a good state to a bad state.

Referring to (a) of FIG. 23, the display device 100 may receive a video having a lower resolution compared to the previous one due to a deteriorating data reception environment.

At this time, the display device 100 may calculate a difference between a current viewpoint and a viewpoint at which the low-resolution video should be displayed.

After that, the display device 100 may analyze video frames applied during a period corresponding to the calculated difference.

Based on the analysis result, the display device 100 may lower the sharpness at once at the moment of transition from a scene with a high frequency component to a scene with a low frequency component, for example, at time point A shown in (b) of FIG. 23.

The video at time point A may include a lot of low-frequency components. Since a video and a resolution of the video are sharply changed together, it is hard to recognize for the user that the change of the video resolution is lowered (such as B as shown in (c) of FIG. 23) is relatively lower than other time points. Accordingly, the user is difficult to easily recognize the change in video quality.

After that, when the time point at which a low-resolution video to be output is reached (for example, time point C shown in (a) of FIG. 23), the display device 100 may control the sharpness to change at once (e.g., restore to its original value) such as time point D as shown in (b) of FIG. 23.

At this time, even if the sharpness is restored, as shown in time point E shown in (c) of FIG. 23, since the resolution of the original video has already been lowered at that time point, there may be no or large change than the previous frame(s).

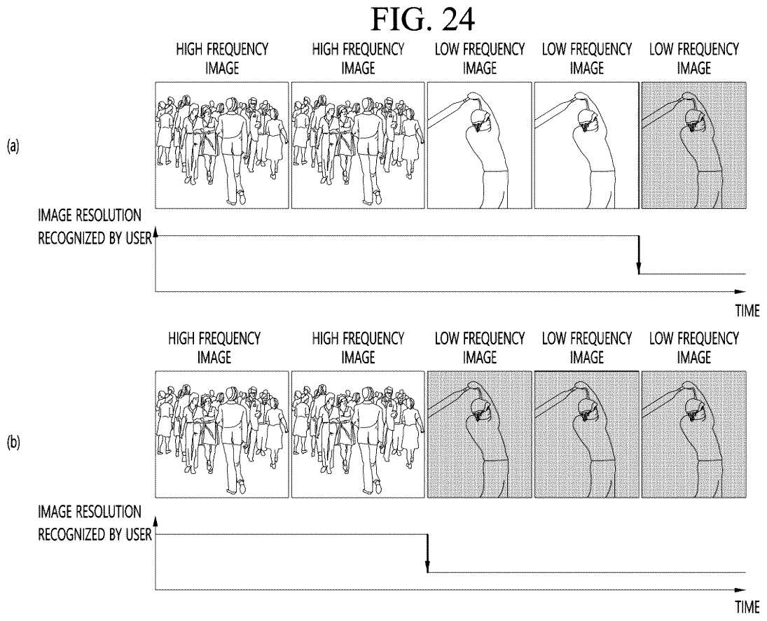

Referring to (a) of FIG. 24, in case video resolution degradation occurs in a scene with a large number of high-frequency components or a scene with a small number of high-frequency components, the user may easily perceive the degradation of the video resolution relatively than other case(s). Therefore, as shown in (b) of FIG. 24, among scene change points, at the time of scene change from a scene with many high-frequency components to a scene with little high-frequency components (or a scene with many low-frequency components), the video resolution perceived by the user is It is possible to control the video to be lowered at once so that the user cannot easily recognize the change (i.e., lowered) of the video resolution through the scene change.

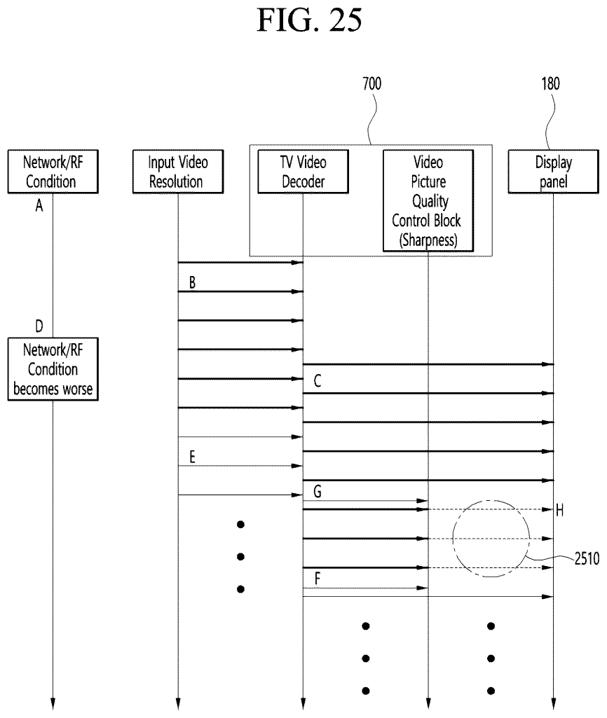

In FIG. 25, an operation sequence diagram of a display device 100 according to another embodiment of the present disclosure is shown.

Referring to FIG. 25, in a state where the network/RF signal environment is good as in A, the display device 100 may receive a high-resolution video signal as in B, and the video decoder 710 decodes the video signal as shown in C, a high-resolution video may be transferred to the display panel 180 and output.

From point D, when the network/RF signal environment deteriorates, the display device 100 may receive a video signal having a lower resolution compared to the previous one, as shown in E.

The video decoder 710 may still transmit a high-resolution video like C to the display panel 180 at point E.

However, the video decoder 710 may sense in advance a point in time when a low-resolution video is supplied to the display panel 180 at point E, that is, point in time F.

Hence, within the time frame between points E and F, the video decoder 710 can exert control over the reduction of sharpness values precisely at the scene change instance, denoted as point G. This specific scene change corresponds to the transition from a high-frequency scene to a low-frequency scene, thereby enabling an immediate reduction in the perceived video resolution for the user.

In relation to this, although the video resolution perceived by the user is also lowered at once due to the rapid decrease in sharpness at the H point, the transition from a high-frequency scene to a low-frequency scene at that point overlaps with the scene change point, so the user may, for example, change the scene Due to the change, it may become relatively insensitive to the change in video resolution, making it difficult to easily recognize it.

At time point F when the video decoder 710 transmits a lower resolution video compared to the previous one to the display panel 180, the previously degraded sharpness is changed once again (e.g., the original sharpness value before deterioration) By controlling, the decrease in original resolution and the increase in sharpness offset each other, so that there is no change in video resolution perceived by the user.

On the other hand, in FIGS. 14, 17, 20, and 23 described above, it is described that the sharpness is lowered or raised at once, but as shown in FIG. 8 or 11, depending on the embodiment, may also be controlled to gradually lower or rise to.

In addition, according to the present disclosure, control content related to video quality may be applied or applied mutatis mutandis to at least one or more combinations of frequency components as well as the aforementioned frame or scene change.

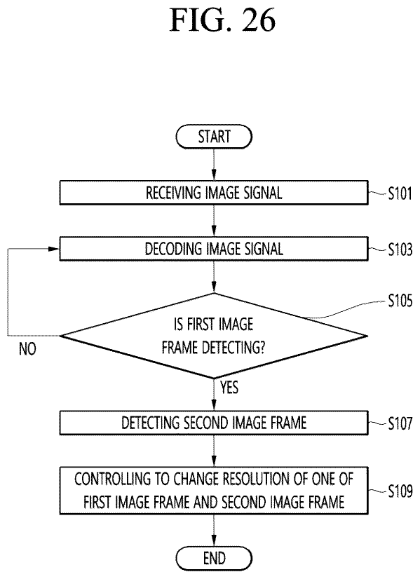

FIG. 26 is a flowchart illustrating an operating method of the display device 100 according to an embodiment of the present disclosure.

Referring to FIG. 26, an operating method of the display device 100 (or processor 700) will be described.

In step S101, the display device 100 may receive a video signal.

In step S103, the display device 100 may decode the received video signal.

In step S105, the display device 100 may determine whether the first video frame is detected. In this case, the first video frame may represent a video frame having a resolution different from that of the previous frame among video frames within the decoded video signal.

In step S107, the display device 100 may detect a second video frame when the first video frame is detected as a result of the determination in step S105. In this case, the second video frame may represent, for example, one or more video frames adjacent to the first video frame.

In step S109, the display device 100 may control resolution change of at least one of the first video frame and the second video frame.

According to the present disclosure, for example, an adaptive bit stream capable of streaming N number of video resolutions is received by the display device 100 through a network, and the corresponding video is a still image and covers many high-frequency regions. In the case of the included test pattern video, the resolution change of the video provided by the display device 100 according to changes such as improvement or deterioration of network conditions is monitored, and there may be more than N changes in video resolution.

According to the present disclosure, for example, an adaptive bit stream capable of streaming three video resolutions is supplied to the display device 100 through a network, wherein one is red color and one is blue color. And the remaining one may compose a video with green color. Afterwards, the resolution change step of the video provided from the display device 100 may be monitored to change the resolution within the same color video according to improvement or deterioration of network conditions.

According to the present disclosure, for example, if a scalable HEVC signal capable of displaying N image resolutions is supplied to the display device 100 through RF, but the image must be a still image and is a test pattern image containing a lot of high-frequency regions, When the RF signal situation improves or deteriorates, it is possible to monitor the change in resolution of the image provided by the display device 100 to determine whether there are more than N levels of resolution change.

According to the present disclosure, for example, a general movie image is supplied to the display device 100, but when the network situation or the RF signal situation improves or deteriorates, the timing of the image resolution change is monitored to determine the scene change timing and the image resolution change timing. It can be checked whether they are in sync with each other. At this time, as a result of the above inspection, if the scene change time and the image resolution change time coincide, or the image resolution changes at the moment of transition from a scene with many high-frequency components to a scene with few high-frequency components (or a scene with many low-frequency components) (i.e. lower) can be done. The opposite is also true.

Meanwhile, before applying various embodiments of the present disclosure, the display device 100 may determine whether to apply them by considering the surrounding environment. For example, in the case of content where the importance of video quality is relatively low, when the brightness of the display device 100 is set low below a predefined value at late times, the user detected by the display device 100 is performing a specific action. In this case, if at least one of the following cases applies, such as when the user detected by the display device 100 is not a pre-registered user, the control of the image quality is controlled differently or not controlled differently compared to each of the above-described embodiments. It can be set or set according to user input. In the above, a specific operation refers to, for example, a user not looking at the panel of the display device 100 for more than a predefined time or using another device such as a mobile terminal that is pre-registered and linked to the display device 100. This may include cases where it is making a video call, voice call, or running a certain application.

Even if not specifically mentioned, the order of at least some of the operations disclosed in the present disclosure may be performed at the same time or in a different order from the previously described order, or some may be omitted/added.

According to an embodiment of the present disclosure, the above-described method can be implemented as processor-readable code on a program-recorded medium. Examples of media that the processor can read include ROM, RAM, CD-ROM, magnetic tape, floppy disk, and optical data storage devices.

The display device described above is not limited to the configuration and method of the above-described embodiments, and the embodiments may be configured by selectively combining all or part of each embodiment so that various modifications can be made. It may be possible.

What is claimed is:

1. A display device comprising:
a video decoder configured to decode video frames;
a display configured to output video; and
a processor configured to:
control a resolution of a first video frame and at least one second video frame, which is adjacent to the first video frame, to be changed, based on the first video frame that is to be output by the display having a resolution that is different from a resolution of a previous video frame having been detected among the video frames decoded by the video decoder.

2. The display device of claim 1, wherein the processor is further configured to:
control the resolution of the first video frame and a plurality of second video frames, of the at least one second video frame, by applying pre-configured quality factor changes to the first video frame and the plurality of second video frames, wherein the quality factor changes comprise a sharpness value.

3. The display device according to claim 2, wherein the processor is further configured to:
control the sharpness value of the first video frame to be reduced, and control the sharpness values for the plurality of second videos frames after the first video frame to sequentially increase, based on the resolution of the first video frame being higher than the resolution of the previous video frame.

4. The display device according to claim 3, wherein the processor is further configured to:
control the reduced sharpness value to be restored to an original set value in a specific video frame among the plurality of second video frames, after the first video frame.

5. The display device according to claim 2, wherein the processor is further configured to:
determine whether a scene change is made in the first video frame.

6. The display device according to claim 5, wherein based on the resolution of the first video frame being higher than the resolution of the previous video frame, and not being a video frame in which the scene change is made, the processor is further configured to:
control the sharpness value of the first video frame to be reduced; and
control the sharpness value of a second video frame, from among the plurality of second video frames, in which the scene change occurs, to be restored to an original setting value.

7. The display device according to claim 6, wherein the processor is further configured to:
control the sharpness value of a second video frame, from among the plurality of second video frames, in which the scene change has not occurred, to be sequentially increased or to have a same sharpness value as the sharpness value of the first video frame.

8. The display device according to claim 2, wherein based on the resolution of the first video frame being lower than the resolution of the previous video frame, the processor is further configured to:
control the sharpness values to be sequentially reduced, relative to the sharpness value of the first video frame, for successive second video frames from among the plurality of second video frames; and
control the sharpness value of further second video frames, from among the plurality of second video frames, to be restored to an original setting value.

9. The display device according to claim 2, wherein based on the resolution of the first video frame being lower than the resolution of the previous video frame, and the first video frame not being a video frame in which a scene change occurs, the processor is further configured to:
control the sharpness value of a second video frame, from among the plurality of second video frames, in which the scene change occurs, to be reduced.

10. The display device according to claim 9, wherein the processor is further configured to:
control the sharpness values to be sequentially reduced of one or more second video frames between the second video frame and the first video frame which is subject to the scene change; or
control the sharpness value of the second video frame and control the sharpness value of the first video frame to be restored to an original set value.

11. The display device according to claim 2, wherein the processor is further configured to:
obtain frequency component information of the decoded video frames; and
detect a video frame whose frequency component is changed, from among the decoded video frames.

12. The display device according to claim 11, wherein the processor is further configured to:
control the sharpness value of the first video frame to maintain an original set sharpness value, based on the resolution of the first video frame being higher than a resolution of the previous video frame or based on no change in the frequency component.

13. The display device according to claim 11, wherein the processor is further configured to:
control the sharpness value of a second video frame whose frequency component is changed, from among the plurality of second video frames, after the first video frame is changed.

14. The display device according to claim 11, wherein based on a video frame whose frequency component is changed, among the decoded video frames, and is not a scene change video frame, the processor is further configured to:
control a resolution to be changed by adjusting a sharpness value of a scene change video frame which is adjacent to the video frame whose frequency component is changed.

15. A method of operating a display device comprising:
receiving a video signal;
decoding the received video signal;
detecting a first video frame having a resolution different from a resolution of a previous frame among a plurality of video frames within the decoded video signal;
detecting at least one second video frame adjacent to the first video frame; and
controlling the resolution of the first video frame and at least one second video frame to be changed, based on the first video frame that is to be output by the display including the resolution that is different from the resolution of the previous video frame.

16. The method of claim 15, further comprising:
controlling the resolution of the first video frame and a plurality of second video frames, of the at least one second video frame, by applying pre-configured quality factor changes to the first video frame and the plurality of second video frames, wherein the quality factor changes comprise a sharpness value.

17. The method of claim 16, further comprising:
controlling the sharpness value of the first video frame to be reduced, and control the sharpness values for the plurality of second videos frames after the first video frame to sequentially increase, based on the resolution of the first video frame being higher than the resolution of the previous video frame.

18. The method of claim 17, further comprising:
controlling the reduced sharpness value to be restored to an original set value in a specific video frame among the plurality of second video frames, after the first video frame.

19. The method of claim 16, wherein based on the resolution of the first video frame being lower than the resolution of the previous video frame, the method further comprises:
controlling the sharpness values to be sequentially reduced, relative to the sharpness value of the first video frame, for successive second video frames from among the plurality of second video frames; and
controlling the sharpness value of further second video frames, from among the plurality of second video frames, to be restored to an original setting value.

20. The method of claim 16, wherein based on the resolution of the first video frame being lower than the resolution of the previous video frame, and the first video frame not being a video frame in which a scene change occurs, the method further comprises:
controlling the sharpness value of a second video frame, from among the plurality of second video frames, in which the scene change occurs, to be reduced.
